(19) United States
(12) Patent Application Publication
(10) Pub. No.: US 2003/0179581 A1
(43) Pub. Date: Sep. 25, 2003

(54) Electric lighting device in the form of a candle

(76) Inventor: Helmut Swarovski, Fritzens (AT)

Correspondence Address: WENDEROTH, LIND & PONACK, L.L.P., 2033 K STREET N. W., SUITE 800, WASHINGTON, DC, 20006-1021, US

(21) Appl. No.: 10/388,507

(22) Filed: Mar. 17, 2003

(30) Foreign Application Priority Data
Mar. 19, 2002 (AU) A 413/2002

(51) Int. Cl. F21V 21/00

(52) U.S. Cl. 362/392; 362/393; 362/396; 362/810

(57) ABSTRACT

Electric lighting device in the form of a candle, in particular a Christmas tree candle with at least one light source and a mechanical holding device for detachable attachment to a support, in particular a tree branch, the electric lighting device comprising a candle stem and a lighting section in the style of in particular a flame and the candle stem (4) and the lighting section (5) consisting of a transparent material which is preferably polished in a facetted manner.

The present invention relates to an electric lighting device in the form of a candle, in particular a Christmas tree candle with at least one light source and a mechanical holding device for detachable attachment to a support, in particular a tree branch, the electric lighting device comprising a candle stem and a lighting section in the style of in particular a flame.

For many people the festive decoration of the home at Christmas time and above all the dressing of the Christmas tree on Christmas eve is not just a much-loved tradition, but also represents for them a possibility of mental preparation for Christmas. Candles are naturally indispensable for a festive decoration of the Christmas tree. However naked flames represent a great safety risk above all for children, for which reason people are increasingly switching to the use of artificial Christmas tree lighting. This explains the great variety of already known electric Christmas tree candles.

DE 197 34 345 A1 and DE 9 320 336 U1 disclose for example an electric candle light, wherein on the top side of a candle stem housing a battery in a transparent casing based on a flame, a light source is attached in the form of a light-emitting diode. DE 198 14 231 A1 also describes an electric light in the form of a candle, wherein on the top side of the opaque candle stem, a light source is attached in a transparent casing. The problem in this context, is that Christmas tree candles made of plastic are not accepted by many people as a substitute for the more festive wax candles.

The object of the invention is to create an electric lighting device in the form of a candle which is simple in terms of design and is optically attractive.

This is achieved according to the invention in that the candle stem and the lighting section consist of a transparent material which is preferably polished in facetted manner.

A technical advantage of this invention is the possibility of arranging the light source not above the candle stem but for example in the area of the mechanical holding device, which simplifies the power supply in technical terms. An economical advantage of this invention is the possibility of designing both the lighting section and the candle stem in an optically attractive manner which increases acceptance among customers.

An advantageous version of the invention follows from the fact that glass is used as transparent material. This makes a large variety of variants possible through the use of coloured glass with comparatively low production costs. Gemstones could of course also be used as transparent material, but this results in an increased selling price.

A further advantageous variant of the invention follows from the fact that the candle stem can be detachably inserted into the mechanical holding device. This makes possible an easy removal of the glass bodies for cleaning purposes and the convenient replacement of for example button batteries fitted in the mechanical holding device.

A further advantageous version of the invention follows from the fact that power is supplied to the light sources via batteries or accumulators arranged in the electric lighting device. The fitting of the batteries in the mechanical holding device avoids the need for optically less attractive cables.

As many people could feel the replacement of empty batteries to be tiresome, it can be provided in a further advantageous version of the invention that power is supplied to the light sources externally via leads.

A further advantageous version of the invention follows from the fact that a light-emitting diode (LED) is chosen as light source. This combines a compact construction and a great luminosity with low current consumption.

A further advantageous version of the invention follows from the fact that the mechanical holding device comprises a spring-loaded clamp which in itself is naturally state of the art. This makes possible the quick placing of the electric lighting device on a tree branch.

A further advantageous version of the invention follows from the fact that the light sources are attached to the mechanical holding device. Thus only the mechanical holding device, and not the entire electric lighting device, has to be replaced in the case of a defective light source.

A further advantageous variant of the invention consists of an electric lighting device in the form of a candle, in particular a Christmas tree candle with at least one light source and a mechanical holding device for detachable attachment to a support, in particular a tree branch, the electric lighting device comprising a candle stem and a lighting section in the style of in particular a flame, and the light source(s) being arranged—preferably exclusively—underneath the candle stem and preferably lying against this, the light emitted from the light source(s) extending at least in part over the candle stem into the lighting section lying above same. Because the light sources themselves are not visible from outside in, an optically attractive, indirect illumination of the Christmas tree candle takes place.

A further advantageous version of the invention follows from the fact that light is supplied to the lighting section exclusively through the candle stem. The light entering the candle stem from below is guided for example via total reflection into the upper lighting section, where it finally emerges from the material. This limits the light emission to a limited area of the lighting section (lighting zone), which produces an extremely optically attractive effect. This is particularly advantageously carried out in that the lighting section is conically tapered to a tip at the top. The candle stem could of course also be at least partly covered with a reflecting layer.

It would also of course be possible to arrange a light source in a bore located on the candle stem, power being supplied to the light source by conductor lines deposited onto the candle stem.

A further advantageous form of the invention follows from the fact that the lighting section is developed as a separate part in the shape of a flame and attached to the candle stem, for example glued on. This makes possible a separate manufacture of the two parts.

A further advantageous version of the invention follows from the fact that the candle stem and the lighting section are developed in one piece. Particularly advantageous design possibilities thereby result.

A further advantageous version of the invention follows from the fact that a power supply is provided which triggers the light source(s) such that these emit a flickering light. The imitation of the natural flickering of a candle flame increases acceptance of the electric Christmas tree candles among customers.

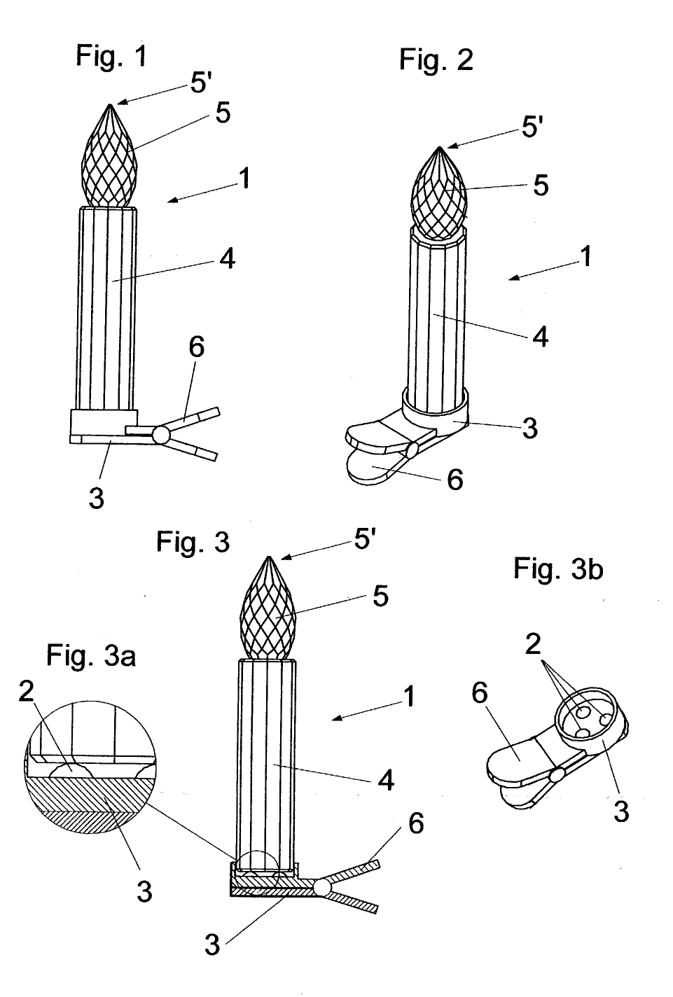

Further details and advantages of the invention are described in more detail in the following using FIGS. 1 to 4 by way of example.

There is shown in:

FIG. 1 an embodiment of a lighting device according to the invention in side view;

FIG. 2 this lighting device in perspective view;

FIGS. 3, 3a, 3b a section through the mechanical holding device with fitted candle stem, a detail of the candle stem lying on the light sources and a perspective view of the mechanical holding device without the fitted candle stem and

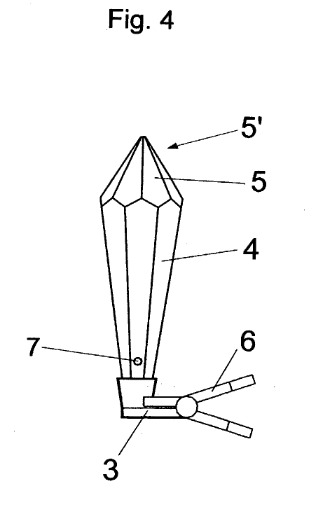

FIG. 4 a side view of an electric lighting device developed in one piece.

FIG. 1 shows an electric lighting device in the form of a candle 1, the lighting section 5 being developed as a separate part in the form of a flame and attached to the candle stem 4. The upper part of the lighting section 5 is conically tapered to a tip 5′. The mechanical holding device 3 comprises a spring-loaded clamp 6 through which the electric lighting device can be attached for example to a tree branch.

FIG. 2 shows the same lighting device in perspective view.

FIG. 3 shows the light sources 2 arranged in the mechanical holding device 3, here in the form of light-emitting diodes. The detail (FIG. 3a) shows that the candle stem 4 is inserted into the mechanical holding device 3 such that it lies on the light sources 2 located below it. The light emitted from the light sources 2 can thereby optimally enter the candle stem 4 and in this embodiment is guided by total reflection into the lighting section 5 developed as a flame. As the lighting section 5 is tapered conically to a tip 5′ at the top, the geometric conditions for a total reflection do not obtain there, which is why the light preferably emerges from the material in this area. An aesthetically extremely attractive bright light, limited to this area, thus forms. In FIG. 3b the mechanical holding device 3 can be seen in perspective view without a fitted candle stem. In this embodiment, three light sources 2 in the form of light-emitting diodes can be seen in the mechanical holding device 3.

FIG. 4 shows an electric lighting device according to the invention in which the candle stem 4 and the lighting section 5 are developed in one piece. A bore 7 into which a light-emitting diode can be introduced, can also be seen.

In all the figures, for reasons of clarity, the batteries supplying the light sources, or cables in the case of an external power supply have not been shown.

1. Electric lighting device in the form of a candle, with at least one light source, and a mechanical holding device for detachable attachment to a support, the electric lighting device including a candle stem and a lighting section in the style of a flame, characterized in that the candle stem and the lighting section consist of a transparent material.

2. Electric lighting device according to claim 1, characterized in that the transparent material is glass.

3. Electric lighting device according to claim 1, characterized in that the candle stem is detachably attached or inserted in the mechanical holding device.

4. Electric lighting device according to claim 1, characterized in that the lighting section consists at least partly of coloured material.

5. Electric lighting device according to claim 1, characterized in that the candle stem and the lighting section are developed in one piece.

6. Electric lighting device according to claim 1, characterized in that the lighting section is developed as a separate part in the form of a flame and attached to the candle stem.

7. Electric lighting device according to claim 1, characterized in that the lighting section is conically tapered to a tip at the top.

8. Electric lighting device according to claim 1, characterized in that the mechanical holding device comprises a spring-loaded clamp.

9. Electric lighting device according to claim 1, characterized in that at least one light source is a light-emitting diode (LED).

10. Electric lighting device according to claim 1, characterized in that power is supplied to the light source(s) externally via conductor lines.

11. Electric lighting device according to claim 1, characterized in that power is supplied to the light source(s) via batteries or accumulators arranged in the electric lighting device.

12. Electric lighting device according to claim 1, characterized in that the light source(s) is (are) attached to the mechanical holding device.

13. Electric lighting device in the form of a candle with at least one light source and a mechanical holding device for detachable attachment to a support, the electric lighting device comprising a candle stem and a lighting section in the style of a flame, characterized in that the light source(s) is (are) arranged underneath the candle stem, the light emitted from the light source(s) travelling at least in part over the candle stem into the lighting section lying above same.

14. Electric lighting device according to claim 13, characterized in that light is supplied to the lighting section exclusively through the candle stem.

15. Electric lighting device according to claim 1, characterized in that a power supply is provided which triggers the light source(s) such that these emit flickering light.

16. Electric lighting device according to claim 1, characterized in that it is a christmas tree candle adapted to be attached to a tree branch.

17. Electric lighting device according to claim 1, characterized in that the candle stem and/or the lighting section of the candle is provided with a facetted surface.
